(19) United States
(12) Patent Application Publication
(10) Pub. No.: US 2026/0027738 A1
(43) Pub. Date: Jan. 29, 2026

(54) RAZOR ASSEMBLY

(71) Applicant: DORCO CO., LTD., Seoul (KR)

(72) Inventors: Ji Hun KI, Seoul (KR); Da Woon HAN, Seoul (KR); Sang Hun PARK, Seoul (KR)

(21) Appl. No.: 19/342,178

(22) Filed: Sep. 26, 2025

Related U.S. Application Data
(63) Continuation of application No. PCT/KR2024/003966, filed on Mar. 28, 2024.

(30) Foreign Application Priority Data
Mar. 28, 2023 (KR) 10-2023-0040806
May 26, 2023 (KR) 10-2023-0068696
Jul. 21, 2023 (KR) 10-2023-0095160

(51) Int. Cl. B26B 21/22; B26B 21/40

(52) U.S. Cl. CPC B26B 21/225; B26B 21/4012; B26B 21/4075

(57) ABSTRACT

A razor assembly includes a razor cartridge and a razor handle that pivotably supports the razor cartridge. The razor cartridge includes at least one blade having a cutting edge, and a blade housing that accommodates the blade in a longitudinal direction and has a connector provided on one side. The blade housing may include an upper surface exposing the cutting edge, a lower surface opposite to the upper surface, and a rinsing area extending from the upper surface to the lower surface and across which the blade is disposed in the longitudinal direction. The razor handle may include a plunger that provides a pivot restoring force to the razor cartridge, and when viewed from the lower surface of the blade housing, the plunger may be positioned so as not to overlap the rinsing area in a rest position.

### CROSS REFERENCE TO RELATED APPLICATIONS

This is a continuation application of International Patent Application No. PCT/KR2024/003966 filed on Mar. 28, 2024, which claims priority to Korean patent application No. 10-2023-0040806 filed on Mar. 28, 2023, Korean patent application No. 10-2023-0068696 filed on May 26, 2023, and Korean patent application No. 10-2023-0095160 filed on Jul. 21, 2023, contents of each of which are incorporated herein by reference in their entireties.

### BACKGROUND

### Technical Field

The present disclosure relates to a razor assembly, and more particularly, to a razor assembly including a washable razor cartridge.

### Description of Related Technology

Razor assemblies generally include a razor cartridge and a razor handle. The razor cartridge comprises a blade housing in which one or more blades are accommodated, and further includes a guard, a cap, and a connector formed as part of the blade housing. The razor handle includes a plunger configured to return the pivotable razor cartridge to a rest position. Since the razor cartridge comes into direct contact with a user's skin and cuts body hair, it requires periodic cleaning to maintain hygiene. The razor should be washed so that the shaving residue (e.g., shaving cream, cut hair, etc.) is flushed out after shaving.

### SUMMARY

One aspect is a razor assembly in which the rinsing region of the razor cartridge is directly exposed to the outside.

Another aspect is a razor assembly capable of distributing rinsing water flowing over the top surface of the plunger throughout the entire rinsing region of the razor cartridge.

The aspects of the disclosure are not limited to those described herein, and other aspects not mentioned herein may become apparent to those skilled in the art from the following description.

Another aspect is a razor assembly comprising a razor cartridge and a razor handle that pivotably supports the razor cartridge, wherein the razor cartridge comprises at least one blade having a cutting edge, and a blade housing that accommodates the blade in a longitudinal direction and has a connector provided on one side, wherein the blade housing comprises an upper surface exposing the cutting edge, a lower surface opposite to the upper surface, and a rinsing area extending from the upper surface to the lower surface and across which the blade is disposed in the longitudinal direction, wherein the razor handle comprises a plunger that provides a pivot restoring force to the razor cartridge, and when viewed from the lower surface of the blade housing, the plunger is positioned so as not to overlap the rinsing area in a rest position, one side of the plunger is located on a plane spaced at least ⅛ of a longitudinal width of the rinsing area from the center of the rinsing area toward one side of the rinsing area, and the other side of the plunger is located on a plane spaced at least ⅛ of the longitudinal width of the rinsing area from the center of the rinsing area toward the other side of the rinsing area.

Other details of the disclosure are included in the detailed description and the accompanying drawings.

According to the embodiments of the disclosure, the effects are at least as follows.

The rinsing region of the razor cartridge is fully exposed to the outside, allowing shaving residue to be smoothly discharged after use.

Rinsing water flowing over the upper surface of the plunger is distributed across the entire rinsing region of the razor cartridge, further enhancing the removal of shaving residue.

Because the leading end of the plunger is brought into close contact with the razor cartridge, rinsing water flowing across the boundary between the cartridge and the plunger is not lost but effectively guided into the rinsing region.

The shape of the plunger can be freely designed regardless of the shape of the central portion of the cartridge, allowing greater design flexibility.

The effects of the disclosure are not limited to those described above, and various other effects are included in the foregoing description.

### BRIEF DESCRIPTION OF THE DRAWINGS

FIG. 1 is a schematic side view of a razor assembly according to an embodiment of the present disclosure.

FIG. 2 is a bottom view of area A in FIG. 1, showing the rest position.

FIG. 3 is a cross-sectional view taken along line III-III of FIG. 2.

FIG. 4 is an exploded perspective view of the components shown in FIG. 2.

FIG. 5 is a view illustrating an extension plane of the upper surface of the plunger shown in FIG. 2.

FIG. 6 is a view showing a vertical plane passing through the leading end of the plunger in FIG. 2.

FIG. 7 is a view illustrating an effective rinsing guide region of the present disclosure.

FIG. 8 is a view illustrating the diffusion path of rinsing water guided into the rinsing region of the present disclosure.

FIG. 9 is a cross-sectional view showing the razor cartridge in a maximum pivoted state, based on FIG. 3.

FIG. 10 is a view illustrating positional changes in contact points between the plunger and the blade housing in response to pivoting of the razor cartridge.

FIG. 11 is a view showing the interior of the plunger housing shown in FIG. 2.

FIG. 12 is a schematic cross-sectional view of the plunger housing shown in FIG. 2.

### DETAILED DESCRIPTION

Shaving residue may be discharged along with rinsing water through a rinsing region formed in the razor cartridge. However, in conventional razor assemblies, the connector or plunger may partially cover the rinsing region due to the structural coupling between the cartridge and the handle. These elements may obstruct the flow of rinsing water and prevent the smooth discharge of shaving residue.

To address this issue, a design approach has been employed in which the width of the plunger is made equal to or smaller than the width of a central portion formed at the rear of the razor cartridge. This central portion is formed along the transverse direction of the blade housing and may serve to support the blades or guide the cam motion of the plunger.

However, such a configuration having a narrow plunger may hinder rinsing water from spreading effectively from the upper surface of the plunger into the rinsing region, thereby reducing the expected cleaning performance. In addition, because the plunger must be designed to match the width of the central portion, there is a limitation in the freedom to design the shape and structure of the plunger.

The advantages and characteristics of the disclosure and a method for achieving the advantages and characteristics will become more apparent from embodiments described below in detail in conjunction with the accompanying drawings. However, the disclosure is not limited to the disclosed embodiments, but may be implemented in various different ways. The embodiments are provided to only complete the disclosure and to allow those skilled in the art to understand the category of the disclosure. The disclosure is defined by the category of the claims.

In addition, embodiments of the disclosure will be described with reference to cross-sectional views and/or schematic views as idealized exemplary illustrations. Therefore, the illustrations may be varied in shape depending on manufacturing techniques, tolerance, and/or etc. Further, elements in the drawings may be relatively enlarged or reduced for convenience of description. Like numerals refer to like elements throughout.

Hereinafter, embodiments of the present disclosure will be described with reference to the drawings illustrating a razor assembly. In the drawings, the longitudinal direction refers to a direction parallel to the x-axis, the transverse direction refers to a direction parallel to the y-axis, i.e., a direction perpendicular to the longitudinal direction in which the blades extend, and the vertical direction refers to directions parallel to the negative and positive z-axes, respectively. In addition, in the front-rear directions, the front direction refers to the negative y-axis direction that first comes into contact with a user's skin during a shaving stroke, and the rear direction refers to the positive y-axis direction that subsequently comes into contact with the user's skin during the shaving stroke.

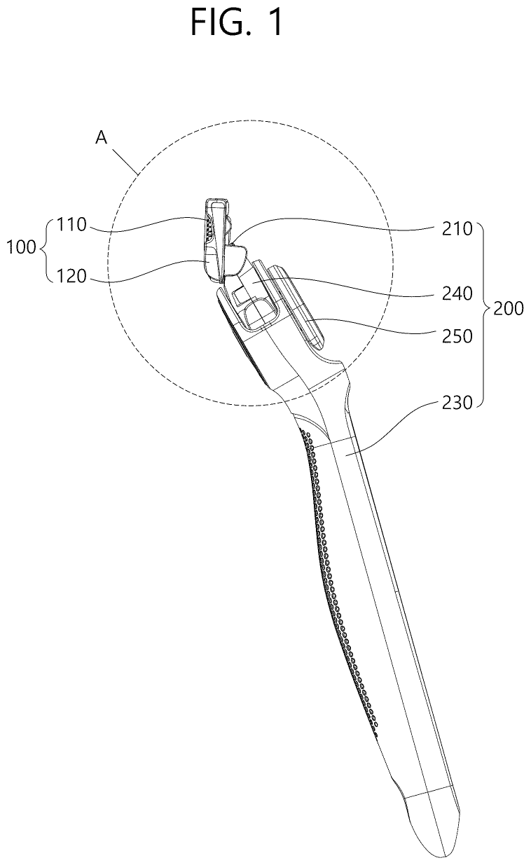

FIG. 1 is a schematic side view of a razor assembly according to an embodiment of the present disclosure.

Referring to FIG. 1, a razor assembly 10 according to an embodiment of the present disclosure is configured to cut body hair, such as fine hair or beard, of a user, and comprises a razor cartridge 100 and a razor handle 200. The razor cartridge 100 is a component that directly contacts the user's skin and cuts the body hair, and the razor handle 200 is a component coupled to the razor cartridge 100 and gripped by the user.

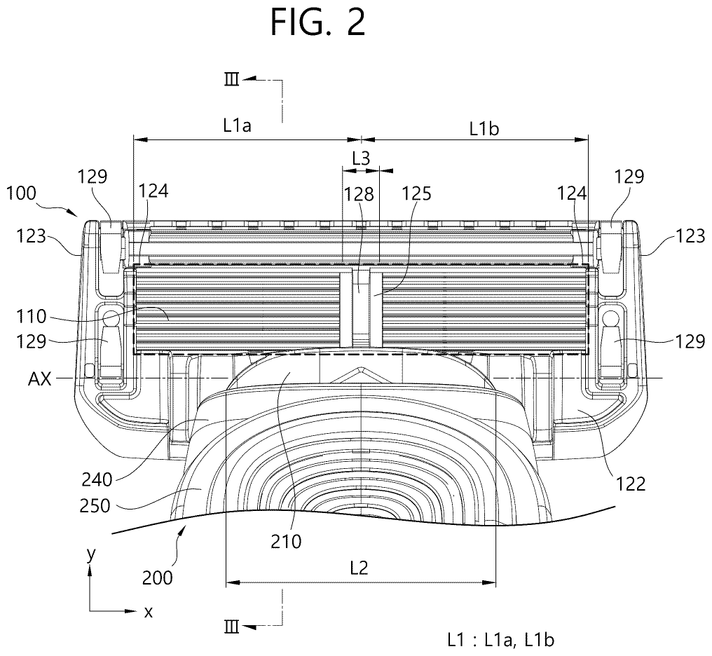

FIG. 2 is a bottom view of region A of FIG. 1 in a rest position.

Referring to FIG. 2, the razor cartridge 100 is pivotably supported by the razor handle 200, and may comprise at least one blade 110 and a blade housing 120.

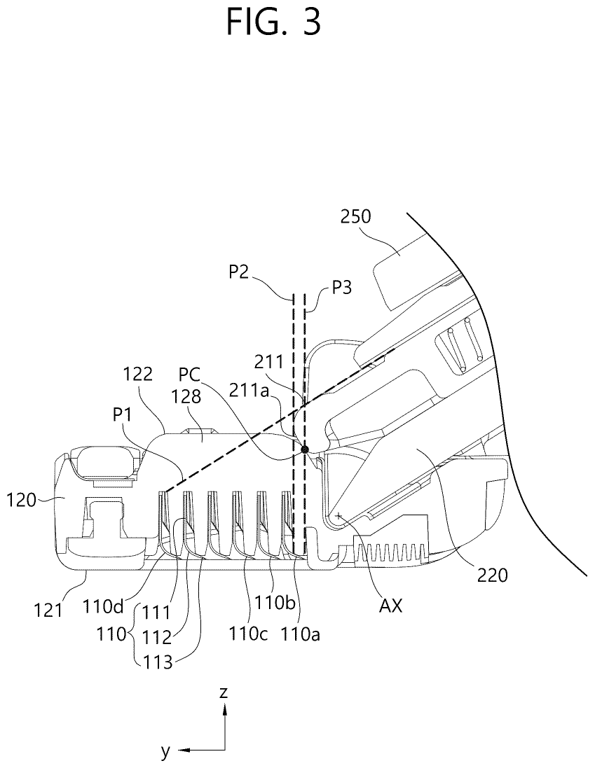

The blade 110 is exposed as a shaving plane formed on an upper surface 121 (see FIG. 3), of the blade housing 120 and cuts the user's body hair. The blade 110 may be formed of a rigid material such as steel.

The shaving plane may refer to an imaginary plane connecting a guard (not shown) positioned at a front portion of the blade housing 120 and a cap not shown positioned at a rear portion of the blade housing 120.

The blade 110 may be disposed in a longitudinal direction (x-axis direction) and received inside the blade housing 120, which forms a body of the razor cartridge 100.

FIG. 3 is a cross-sectional view taken along line III-III of FIG. 2.

Referring to FIG. 3, the blade 110 may comprise a base portion 111, a bent portion 112, and a cutting edge 113. The base portion 111 forms a body of the blade 110 and may be supported by the blade housing 120. The bent portion 112 bents and extends from an upper end of the base portion toward a front portion of the blade housing 120. The cutting edge 113 extends from an upper end of the bent portion 112, is exposed on the shaving plane of the razor cartridge 100, and cuts the user's body hair.

Meanwhile, the cutting edge 113 of the blade 110a, which is located at the foremost position, may be positioned between the foremost end 211a of the plunger 210, described later, and the contact point PC between the plunger 210 and the blade housing 120. More specifically, when the razor cartridge 100 is in the rest position, the cutting edge 113 of the blade 110a at the foremost position may be located between a first vertical surface P2, which is perpendicular to the upper surface 121 and in contact with the foremost end 211a of the plunger 210, and a second vertical surface P3, which is perpendicular to the upper surface 121 and passes through the contact point PC. Related details are described later in the description of the plunger 210.

The blade 110 is disclosed as a bended blade including a base portion 111, a bent portion 112, and a cutting edge 113, but the present disclosure is not limited thereto, and according to an embodiment, the cutting edge 113 may be welded to one side of the base portion 111 to form a welded blade fixed in place.

The blades 110 may be spaced apart from each other and arranged in plurality. In FIGS. 2 and 3, six blades 110 are illustrated as being arranged, but the number of blades 110 may vary according to an embodiment of the present disclosure.

Among the plurality of blades 110, the blade 110a located at the foremost position may be positioned rearward relative to the pivot axis AX of the razor cartridge 100. The pivot axis AX is an axis passing through a pair of connectors 127, formed on the rear of the razor cartridge 100 and described later, and may be a fixed axis or an axis movable within a certain range. By positioning the pivot axis AX forward of the foremost blade 110, i.e., in the direction toward which the cutting edge 113 faces, the rinsing area 124 of the razor cartridge 100, described later, may be exposed to the outside without being blocked by the connectors 127 of the razor cartridge 100 or the plunger 210 of the razor handle 200, described later.

Meanwhile, when the razor cartridge 100 is in the rest position, the foremost blade 110a may be positioned rearward of the plunger 210 and the contact point PC of the blade housing 120, and when the razor cartridge 100 is at the maximum pivot position, the second or third blade 110b, 110c from the front may be positioned rearward of the plunger 210 and the contact point PC of the blade housing 120. Related details are described later in the description of the plunger 210.

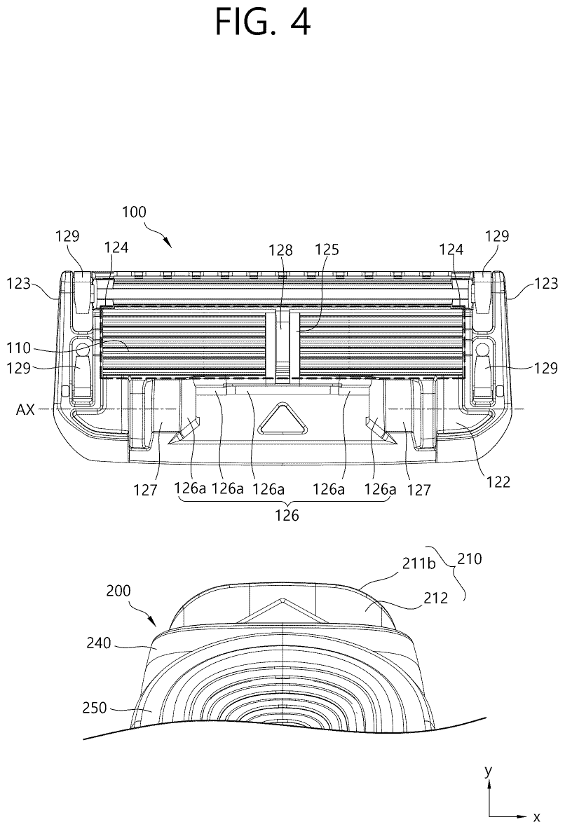

FIG. 4 is an exploded perspective view of FIG. 2.

Referring to FIGS. 2 and 4, the blade housing 120 accommodates the blade 110 in the longitudinal direction (x-axis direction) and may form the body of the razor cartridge 100. The blade housing 120 includes an upper surface 121, a lower surface 122, see FIG. 3, and side surfaces 123 forming the body of the razor cartridge 100, a rinsing area 124 through which shaving cream, cut hair, and other shaving residues are discharged, a central portion 125 supporting the blade 110 or supporting the cam motion of the plunger 210, a cam 128 contacting the razor handle 200, more specifically the plunger 210, to restrict the pivot motion of the razor cartridge 100, a connector 127 coupled to the razor handle 200, and a plunger-facing surface 126 positioned adjacent to the tip 211 of the plunger 210, described later.

In addition, the blade housing 120 may include a clip 129 preventing the ejection of the accommodated blade 110, a guard (not shown) contacting the user's skin and pulling the skin during shaving, and a lubricating band (not shown) containing a lubricating material to protect the user's skin. Since the clip 129, guard, and lubricating band of the present disclosure are similar to those in the prior art, detailed description thereof is omitted.

The upper surface 121 of the blade housing 120 is a surface that contacts or faces the user's skin during shaving and may be the surface toward which the cutting edge 113 of the blade 110 faces. The lower surface 122 of the blade housing 120 may be a surface positioned opposite to the upper surface 121. The side surfaces 123 of the blade housing 120 are surfaces connecting the upper surface 121 and the lower surface 122 and may be integrally formed with the upper and lower surfaces.

The rinsing area 124 is an area in which the blades 110 are arranged and shaving residues are discharged, and may be formed to pass through from the upper surface 121 to the lower surface 122 of the blade housing 120. The rinsing area 124 is an area through which rinsing water and shaving residues pass and are discharged to the outside. In addition, by forming the pivot axis AX forward of the foremost blade 110a, the rinsing area 124 may be exposed to the outside without being blocked by the connector 127 of the razor cartridge 100 or the plunger 210 of the razor handle 200, described later.

In one embodiment of the present disclosure, the rinsing area 124 includes a region comprising the central portion 125, a rib (not shown), and the like. The components that may be included in the rinsing area 124 are not limited to the central portion 125 and the rib and may include various other configurations. For smooth discharge of shaving residues, the longitudinal width L1 of the rinsing area 124 may be given as a specific value. Referring to FIG. 2, the longitudinal width L1 of the rinsing area 124 refers to the distance from one side to the other side of the rinsing area 124. One side of the rinsing area 124 refers to the edge portion located at the end in the negative x-axis direction in FIG. 2, and the other side refers to the edge portion located at the end in the positive x-axis direction in FIG. 2.

Referring to FIG. 2, the longitudinal width L1 of the rinsing area 124 may be 25 mm to 35 mm, and preferably 29 mm to 34 mm. However, the above numerical ranges are merely exemplary and not limiting. When the rinsing area 124 is bisected by a line parallel to the transverse direction, the longitudinal widths L1a and L1b of the bisected rinsing areas may be equal to each other.

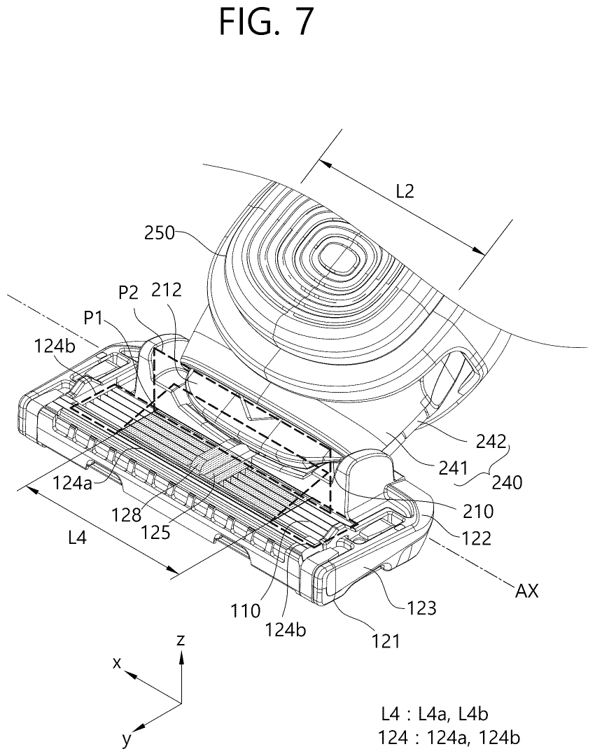

The rinsing area 124 may include an effective rinsing guide region 124a, see FIG. 7, in which rinsing water is guided by the plunger 210 of the razor handle 200, described later, and a non-effective rinsing guide region 124b, see FIG. 7, where the rinsing water diffused from the effective rinsing guide region 124a flows in. Specific details of the effective rinsing guide region 124a and the non-effective rinsing guide region 124b are described later in the description of the plunger 210 of the razor handle 200.

The central portion 125 may be extended across the center of the rinsing area 124 in the transverse direction (y-axis direction) on the lower surface 122 of the blade housing 120.

The central portion 125 may support the blade 110 or support the cam motion of the plunger 210.

In addition, the blade housing 120 may further include a cam 128 at a position on the central portion 125 that contacts the plunger 210 to restrict the pivot motion of the razor cartridge 100.

When the blade housing 120 includes the central portion 125, the rinsing area 124 may be configured as a single area including the central portion 125.

The longitudinal width L3 of the central portion 125 refers to the distance from one side to the other side of the central portion 125. One side of the central portion 125 refers to the edge portion located at the end in the negative x-axis direction in FIG. 2, and the other side refers to the edge portion located at the end in the positive x-axis direction in FIG. 2.

For smooth discharge of shaving residues, the ratio of the longitudinal width L2 of the plunger 210 to the longitudinal width L3 of the central portion 125 may be 2 to 8, preferably 5 to 7. However, the above numerical ranges are merely exemplary and not limiting.

Referring to FIG. 3, the cam 128 contacts the plunger 210 to restrict the pivot motion of the razor cartridge 100 and may be formed to protrude outward from the central portion 125 on the lower surface 122 of the blade housing 120. When the cam 128 contacts the plunger 210, a contact point PC between the plunger 210 and the blade housing 120, described later, may occur between the cam 128 and the plunger 210.

Referring to FIG. 4, the connector 127 may be releasably coupled to a cartridge coupling portion 220 of the razor handle 200, described later. The connector 127 may be provided on one side of the blade housing 120. The connector 127 may include an internal space for accommodating the cartridge coupling portion 220. The structure in which the cartridge coupling portion 220 is inserted into the internal space of the connector 127 and releasably coupled is described later in the description of the cartridge coupling portion 220.

The plunger-facing surface 126 may be positioned adjacent to the tip 211 of the plunger 210 of the razor handle 200, described later, when the razor cartridge 100 and the razor handle 200 are coupled. The plunger-facing surface 126 may correspond to the tip 211 of the plunger 210. For example, when the tip 211 of the plunger 210 includes a convex tip surface 211b facing the rinsing area 124, the plunger-facing surface 126 may include a corresponding curved surface 126a corresponding to the convex tip surface 211b of the plunger 210. When the razor cartridge 100 and the razor handle 200 are coupled, the corresponding curved surface 126a of the plunger-facing surface 126 and the convex tip surface 211b of the plunger 210 may be in close contact, or the distance between them may be minimized. Accordingly, rinsing water passing over the upper surface 212 of the plunger 210 may be guided to the rinsing area 124 without being lost between the plunger-facing surface 126 and the plunger 210.

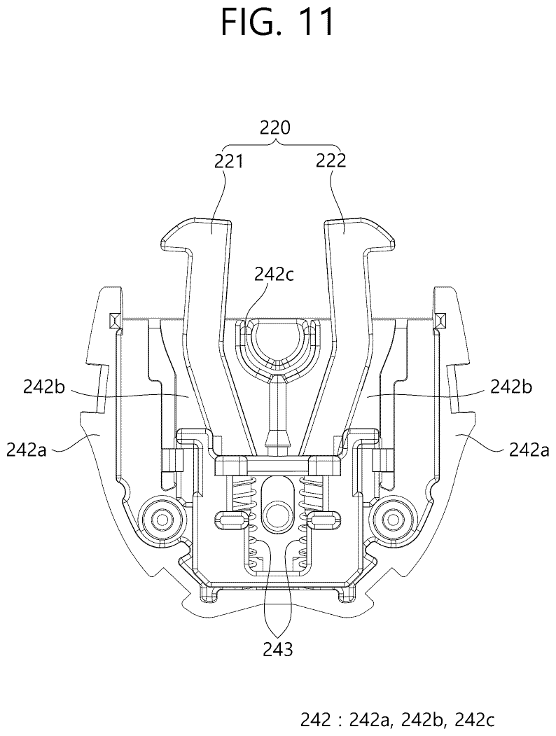

Referring to FIGS. 1 and 2, the razor handle 200 pivotably supports the razor cartridge 100 and may include a grip portion 230, a plunger 210, a plunger housing 240, a cartridge coupling portion 220, see FIG. 11, and an operation portion 250.

The grip portion 230 is the part held by the user and may be formed with a predetermined length to facilitate gripping. The grip portion 230 forms the body of the razor handle 200.

The plunger 210 provides pivot restoring force to the razor cartridge 100 and may elastically support the razor cartridge 100. The plunger 210, supported by an elastic member (not shown), may provide pivot restoring force to restore the razor cartridge 100 pivoted about the pivot axis AX to the rest position.

The rest position of the razor cartridge 100 refers to a state in which the razor cartridge 100 is not pivoted relative to the pivot axis AX with respect to the razor handle 200 when the razor cartridge 100 and the razor handle 200 are coupled.

In addition, the pivot position refers to a position pivoted from the rest position within a certain angular range about the pivot axis AX when the razor cartridge 100 and the razor handle 200 are coupled. The pivot position may include a maximum pivot position pivoted by the maximum angle from the rest position and a partial pivot position pivoted by less than the maximum angle from the rest position.

Referring to FIGS. 2 and 3, when the razor cartridge 100 is in the rest position, the plunger 210 may be arranged so as not to overlap with the rinsing area 124. By arranging the plunger 210 not to overlap the rinsing area 124, the entire rinsing area 124 may be exposed externally without being blocked by the plunger 210.

By forming the plunger 210 so as not to block the rinsing area 124, the plunger 210 may have a greater width and length than conventional plungers. That is, the plunger 210 according to the present disclosure may have a longitudinal width L2 greater than the longitudinal width L3 of the central portion 125, thereby including an upper surface with a larger area than conventional plungers. In addition, since the plunger 210 is not constrained by the shape of the central portion 125, the plunger 210 according to the present disclosure may be designed more freely in shape than conventional plungers.

As the area of the upper surface 212 of the plunger 210 increases, the flow rate of cleaning rinsing guided to the rinsing area 124 along the upper surface 212 of the plunger 210 increases. Accordingly, most of the shaving residues may be discharged externally together with the rinsing water, and the cleaning effect may be significantly improved.

For smooth discharge of shaving residues, one side of the plunger 210 is preferably positioned on a plane spaced at least ⅛ of the longitudinal width L1 of the rinsing area 124 from the center of the rinsing area 124 toward one side, and the other side of the plunger 210 is preferably positioned on a plane spaced at least ⅛ of the longitudinal width L1 of the rinsing area 124 from the center of the rinsing area 124 toward the other side. One side of the plunger 210 and one side of the rinsing area 124 refer to the edge portion located at the end in the negative x-axis direction in FIG. 2, and the other side of the plunger 210 and the other side of the rinsing area 124 refer to the edge portion located at the end in the positive x-axis direction in FIG. 2. The center of the rinsing area 124 refers to the central portion of the rinsing area 124 bisected longitudinally.

For smooth discharge of shaving residues, the longitudinal width L2 of the plunger 210 may be 10 mm to 30 mm, preferably 15 mm to 25 mm. However, the above numerical ranges are merely exemplary and not limiting.

In addition, when the razor cartridge 100 is in the rest position, the exposed area of the upper surface 212 of the plunger 210 may be 0.5 cm² to 1.0 cm², preferably 0.6 cm² to 0.8 cm². However, the above numerical ranges are merely exemplary and not limiting.

The ratio of the longitudinal width L2 of the plunger 210 to the longitudinal width L1 of the rinsing area 124 may be 0.3 to 0.8, preferably 0.5 to 0.7. However, the above numerical ranges are merely exemplary and not limiting.

The tip 211 of the plunger 210 may be adjacent to or in contact with the plunger-facing surface 126 of the blade housing 120. The tip 211 of the plunger 210 may include a convex tip surface 211b facing the rinsing area 124. As described above, since the convex tip surface 211b of the plunger 210 and the corresponding curved surface 126a of the plunger-facing surface 126 are in close contact or the distance between them is minimized, rinsing water passing over the upper surface 212 of the plunger 210 may be guided to the rinsing area 124 without loss.

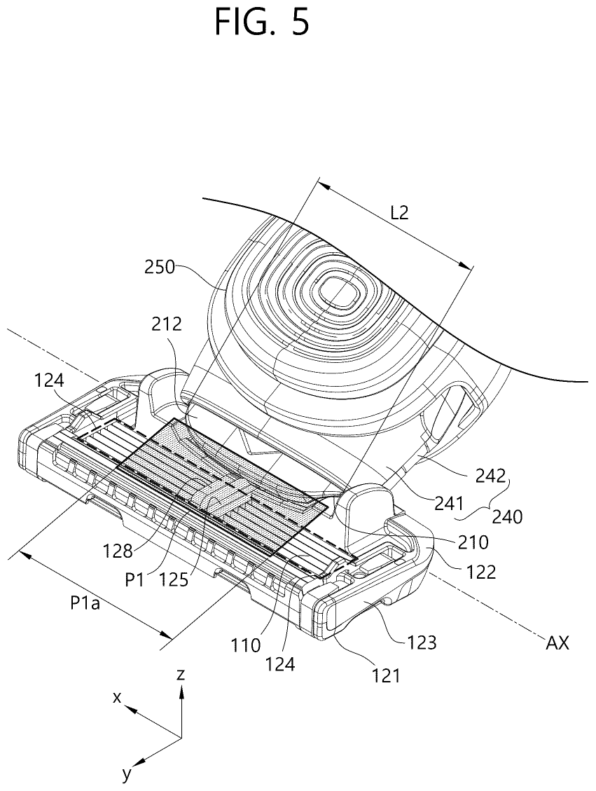

FIG. 5 is a view illustrating an extended plane of the upper surface of the plunger in FIG. 2.

Referring to FIGS. 3 and 5, the extended plane P1 of the upper surface 212 of the plunger 210 may be a virtual plane extending from the tip 211 of the upper surface 212 of the plunger 210. The longitudinal width Pla of the extended plane P1 may be equal to the longitudinal width L2 of the plunger 210. When the razor cartridge 100 is in the rest position, the upper surface 212 of the plunger 210 may be formed such that the extended plane P1 passes through the rinsing area 124. It is preferable that the upper surface 212 of the plunger 210 be formed so that the extended plane P1 passes through the rearmost blade 110d or an area adjacent thereto. Rinsing water guided from the upper surface 212 of the plunger 210 to the rinsing area 124 may fall between the extended plane P1 and the boundary of the rinsing area 124 under the influence of gravity. Most of the rinsing water falls from the tip 211 of the plunger 210 through the boundary between the extended plane P1 and the rinsing area 124 and may be discharged externally together with shaving residues.

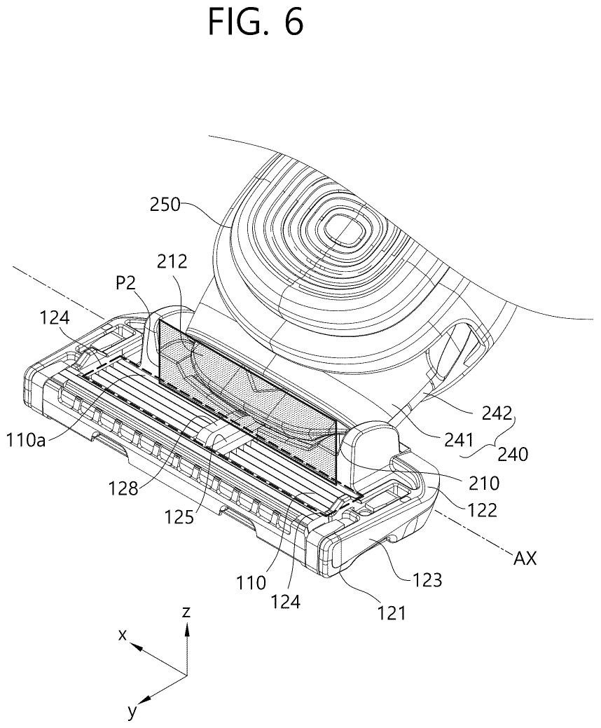

FIG. 6 is a view illustrating a vertical plane passing through the tip of the plunger in FIG. 2.

Referring to FIGS. 3 and 6, when the razor cartridge 100 is in the rest position, the first vertical plane P2 may contact the foremost end 211a of the plunger 210 while passing through the blade 110a located at the foremost position among the plurality of blades 110. The first vertical plane P2 may be a virtual plane perpendicular to the shaving plane. When the razor cartridge 100 is in the rest position, the blade housing 120 and the plunger 210 are arranged so that the first vertical plane P2 passes through the foremost blade 110a, and thus most of the rinsing water guided from the upper surface 212 of the plunger 210 to the rinsing area 124 may fall into the rinsing area 124.

FIG. 7 illustrates the effective rinsing guide region of the present disclosure.

Referring to FIGS. 3 and 7, the effective rinsing guide region 124a may be defined by the aforementioned extended plane P1 and the first vertical plane P2. The rinsing area 124 may include the effective rinsing guide region 124a and the non-effective rinsing guide region 124b. The effective rinsing guide region 124a is a region within the rinsing area 124 where rinsing water passing over the upper surface 212 of the plunger 210 is primarily guided, and the non-effective rinsing guide region 124b is the remaining region within the rinsing area 124 excluding the effective rinsing guide region 124a, adjacent to the effective rinsing guide region 124a.

The effective rinsing guide region 124a may be defined based on the extended plane P1 and the first vertical plane P2. Specifically, the effective rinsing guide region 124a is a region where the extended plane P1 is projected onto the space accommodating the blades 110, overlapping with the rinsing area 124, and contacting the first vertical plane P2. The longitudinal width L4 of the effective rinsing guide region 124a may be equal to the longitudinal width L2 of the plunger 210, regardless of the presence of the central portion 125.

In this case, similar to the rinsing area 124, the effective rinsing guide region 124a may include the central portion 125, a rib (not shown), and the like, and its longitudinal width L4 may be equal to the longitudinal width L2 of the plunger 210. The rib (not shown) is a member extending transversally on both sides of the central portion 125 and may prevent the coupling portion 220 from being incorrectly inserted into the lower surface 122 of the blade housing 120 and damaging the blades 110, or may reinforce the rigidity of the blade housing 120. The longitudinal width of the rib may be 1.3 mm to 2 mm. However, the above numerical ranges are merely exemplary and not limiting.

The area of the effective rinsing guide region 124a may be 30 mm² to 200 mm², preferably 50 mm² to 150 mm². However, the above numerical ranges are merely exemplary and not limiting.

The ratio of the area of the effective rinsing guide region 124a to the area of the rinsing area 124 may be 0.2 to 0.8, preferably 0.3 to 0.7. However, the above numerical ranges are merely exemplary and not limiting.

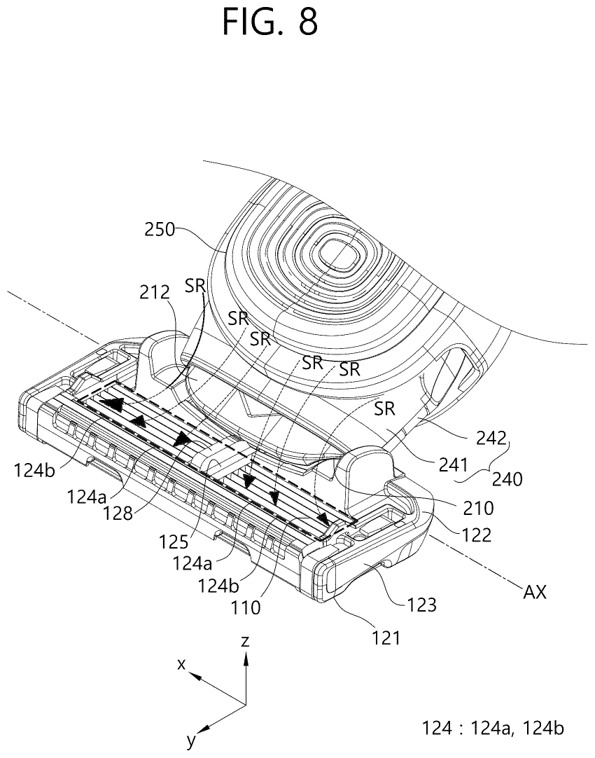

FIG. 8 illustrates the diffusion path of rinsing water guided into the rinsing area of the present disclosure.

Referring to FIGS. 3 and 8, the upper surface 212 of the plunger 210 may include a convex curved region. Rinsing water passing over the convex curved region of the plunger 210 may form a radially spreading diffusion path SR. The rinsing water may be evenly diffused along the diffusion path SR into the effective rinsing guide region 124a and the non-effective rinsing guide region 124b. The plunger 210 including the convex curved region may further enhance the cleaning effect.

Referring to FIG. 3, the contact point PC between the plunger 210 and the blade housing 120 may be located forward of the blade 110a positioned at the foremost among the plurality of blades 110 in the rest position.

When the razor cartridge 100 is in the rest position, since the contact point PC is positioned forward of the foremost blade 110a, the entire rinsing area 124 may be exposed externally without being blocked by the connector 127 of the razor cartridge 100 or the plunger 210.

Referring to FIG. 3, when the razor cartridge 100 is in the rest position, the cutting edge 113 of the foremost blade 110a may be located between the foremost end 211a of the plunger 210 and the contact point PC. More specifically, when the razor cartridge 100 is in the rest position, the cutting edge 113 of the foremost blade 110a may be located between a first vertical plane P2 perpendicular to the upper surface 121 and contacting the foremost end 211a of the plunger 210, and a second vertical plane P3 perpendicular to the upper surface 121 and passing through the contact point PC.

By positioning the cutting edge 113 between the foremost end 211a of the plunger 210 and the contact point PC, the entire rinsing area 124 may be exposed externally without being blocked by the connector 127 of the razor cartridge 100 or the plunger 210. In addition, when the plunger 210 is maximally spaced from the pivot AX, it can appropriately provide a pivot restoring force that presses the upper surface 121 of the blade housing 120 against the user's skin.

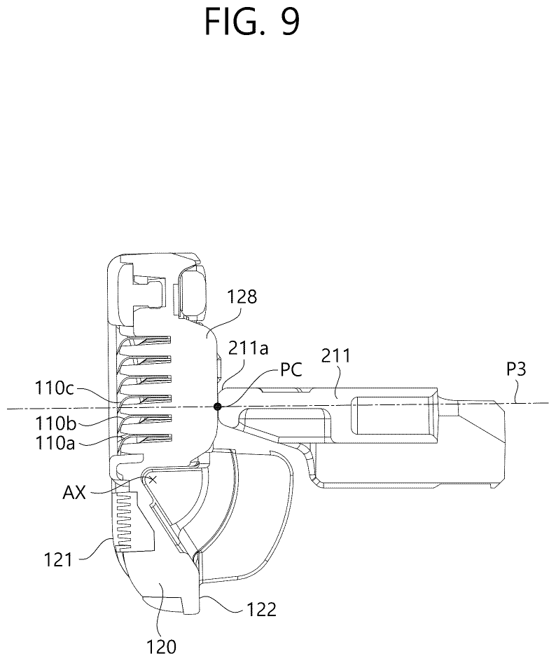

FIG. 9 is a cross-sectional view illustrating the razor cartridge 100 in a maximally pivoted state, based on FIG. 3.

Referring to FIG. 9, the contact point PC between the plunger 210 and the blade housing 120 may be located rearward of the cutting edges of the second or third blade 110b, 110c from the front among the plurality of blades 110 at the maximum pivot position.

More specifically, the second vertical plane P3 may be positioned rearward of the cutting edges of the second or third blade 110b, 110c.

Accordingly, the plunger 210 may provide an appropriately sized pivot restoring force to the razor cartridge 100 during pivoting and press the upper surface 121 of the blade housing 120 against the user's skin.

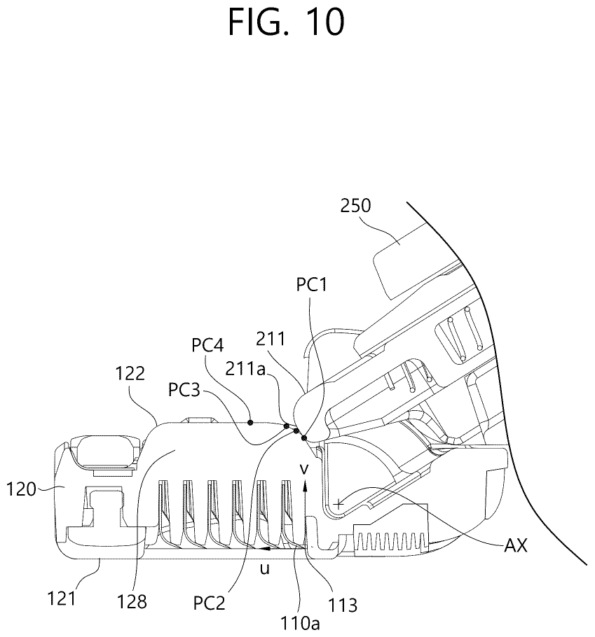

FIG. 10 illustrates the positional changes of the contact point between the plunger and the blade housing according to the pivoting of the razor cartridge.

Referring to FIG. 10, the razor cartridge 100 may contact the user's skin surface and pivot about the pivot AX at a predetermined angle.

The pivot angle may be 0° to 90°, preferably 0° to 45°. However, the above numerical ranges are merely exemplary and not limiting. Hereinafter, the maximum pivot angle is considered to be 0° to 45°, and the positional changes of the contact point PC between the plunger 210 and the blade housing 120 are described.

First, an origin of a coordinate axis corresponding to the intersection of the transversal u-axis and the vertical v-axis is defined. The origin of the uv coordinate is the tip of the cutting edge 113 of the foremost blade 110a. The positive u-axis extends from the cutting edge 113 of the foremost blade 110a toward the cutting edge 113 of the rearmost blade 110d, and the negative u-axis extends in the opposite direction. The positive v-axis extends from the cutting edge 113 of the foremost blade 110a toward the tip 211 of the plunger, and the negative v-axis extends in the opposite direction.

When the razor cartridge 100 is in the rest position, the u-axis coordinate of the contact point PC1 may be −0.5 mm to +1.0 mm, preferably −0.3 mm to +0.5 mm. The v-axis coordinate of the contact point PC1 may be +3.4 mm to +5.3 mm, preferably +3.9 mm to +4.9 mm. However, the above numerical ranges are merely exemplary and not limiting.

When the pivot angle of the razor cartridge 100 is 15°, the u-axis coordinate of the contact point PC2 may be −0.3 mm to +1.2 mm, preferably −0.1 mm to +0.7 mm. The v-axis coordinate of the contact point PC2 may be +3.5 mm to +5.4 mm, preferably +4.0 mm to +5.1 mm. However, the above numerical ranges are merely exemplary and not limiting.

When the pivot angle of the razor cartridge 100 is 30°, the u-axis coordinate of the contact point PC3 may be +0.1 mm to +1.6 mm, preferably +0.3 mm to +1.3 mm. The v-axis coordinate of the contact point PC3 may be +3.7 mm to +5.6 mm, preferably +4.1 mm to +5.3 mm. However, the above numerical ranges are merely exemplary and not limiting.

When the pivot angle of the razor cartridge 100 is 45°, the u-axis coordinate of the contact point PC4 may be +0.6 mm to +2.1 mm, preferably +0.5 mm to +1.9 mm. The v-axis coordinate of the contact point PC4 may be +3.8 mm to +5.8 mm, preferably +4.0 mm to +5.5 mm. However, the above numerical ranges are merely exemplary and not limiting.

When the razor cartridge 100 pivots from the rest position to the maximum pivot angle, since the contact point PC is located within the above numerical ranges, the rinsing area 124 may be externally exposed while being minimally blocked by the connector 127 of the razor cartridge 100, the cartridge coupling portion 220, or the plunger 210 of the razor handle 200. In addition, when the plunger 210 is maximally spaced from the pivot AX, it can provide a pivot restoring force that presses the upper surface 121 of the blade housing 120 against the user's skin.

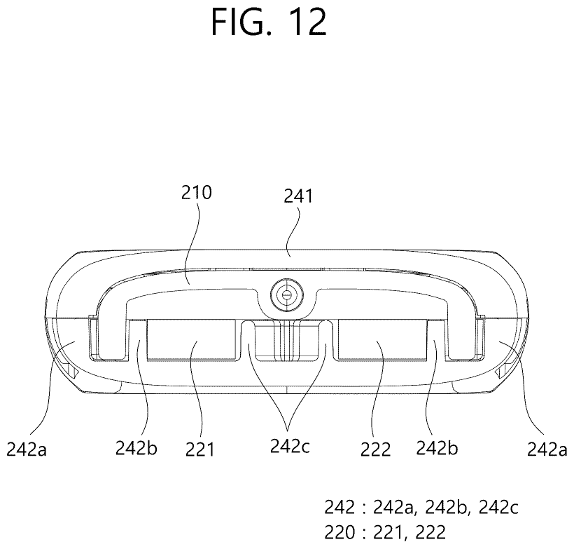

FIG. 11 illustrates the interior of the plunger housing 240 of FIG. 2, and FIG. 12 is a schematic cross-sectional view of the plunger 210 of FIG. 2.

Referring to FIGS. 11 and 12, the plunger housing 240 may slidably support the plunger 210, which provides a pivot restoring force to the razor cartridge 100 via an elastic member (not shown).

The plunger housing 240 may include an upper housing 241 and a lower housing 242. The upper housing 241 and the lower housing 242 may form a space that accommodates the plunger 210 and the first arm 221 and second arm 222 of the cartridge coupling portion 220 described later.

The lower housing 242 may include an outer wall 242a forming an internal space, guide side walls 242b to guide the sliding path of the plunger 210, and a protrusion 242c. The outer wall 242a may be fitted into a groove formed in the interior of the upper housing 241 and may be releasably coupled to the upper housing 241. The guide side wall 242b may protrude inwardly from the outer wall 242a. The protrusion 242c may support the first arm 221 and the second arm 222.

Referring to FIGS. 11 and 12, the cartridge coupling portion 220 may couple with the connector 127 of the razor cartridge 100. The cartridge coupling portion 220 may include a pair of first arm 221 and second arm 222 spaced apart in the longitudinal direction (x-axis direction) along which the blades 110 are arranged. The first arm 221 and second arm 222 may be elastically supported by an elastic body 243, and can be rotated so that one ends become a central axis and the opposite ends may pivot to move closer together or further apart along the longitudinal direction (x-axis direction) about a central axis. When the opposite ends of the first arm 221 and second arm 222 are maximally separated, they may be supported by the protrusion 242c.

As the first arm 221 and second arm 222 pivot, a portion of their opposite ends may be inserted into and detached from the internal space of the connector 127. In addition to the pair of first arm 221 and second arm 222, the cartridge coupling portion 220 may be releasably coupled to the connector 127 of the razor cartridge 100 by other means, such as latch coupling, hook coupling, or boss coupling.

At this time, in addition to the replaceable system razor in which the razor cartridge 100 can be replaced by releasably coupling the razor cartridge 100 and the razor handle 200 as in one embodiment of the present disclosure, a similar coupling method may be adopted for a portable razor that does not replace the razor cartridge 100.

In addition, in FIGS. 1 to 12, the connector 127 is illustrated as being fixed to the blade housing 110, and the coupling portion 220 is pivotably coupled to the connector 127. However, the present disclosure is not limited thereto. For example, in another embodiment of the present disclosure, a rotatable connector in which the connector 127 is pivotably coupled to the blade housing 110 may be employed.

Referring to FIGS. 1, 2, and 11, the operation portion 250 is a part for manipulating the first arm 221 and the second arm 222 of the cartridge coupling portion 220. The operation portion 250 may release the coupling between the first arm 221 and the connector 127 and the coupling between the second arm 222 and the connector 127, thereby allowing the razor cartridge 100 and the razor handle 200 to be separated.

As the operation portion 250 moves toward the razor cartridge 100 in the transverse direction (y-axis), the distance between the opposite ends of the first arm 221 and the second arm 222 may decrease. As the distance between the opposite ends of the first arm 221 and the second arm 222 decreases, a portion of the opposite ends of the first arm 221 and the second arm 222 is disengaged from the internal space of the connector 127, thereby releasing the coupling between the first arm 221 and the connector 127 and the coupling between the second arm 222 and the connector 127.

As described above, the razor assembly 10 of the present disclosure allows the entire rinsing area 124 of the razor cartridge 100 to be externally exposed, thereby enabling smooth discharge of shaving residue after shaving. By spreading the rinsing fluid passing over the upper surface 212 of the plunger 210 throughout the entire rinsing area 124 of the razor cartridge 100, the present disclosure can further facilitate the discharge of shaving residue after shaving. Since the tip 211 of the plunger 210 of the razor handle 200 is in close contact with the razor cartridge 100, the rinsing fluid flowing along the boundary between the razor cartridge 100 and the plunger 210 is not lost and can be guided into the rinsing area 124.

Although exemplary embodiments of the disclosure have been described with reference to the accompanying drawings, the configurations described in the embodiments and depicted in the drawings are merely the most preferred embodiments of the disclosure and do not represent all the technical ideas of the disclosure, and thus it should be understood that there may be various equivalents and variations capable of replacing the embodiments at the time of this application. Accordingly, the embodiments described above are illustrative and not restrictive in all aspects. The scope of the disclosure is defined by the appended claims rather than the foregoing detailed description, and all changes or modifications derived from the meaning and scope of the appended claims and their equivalents are construed as falling within the scope of the disclosure.

What is claimed is:

1. A razor assembly comprising a razor cartridge and a razor handle that pivotably supports the razor cartridge,
wherein the razor cartridge comprises:
at least one blade having a cutting edge, and
a blade housing that accommodates the blade in a longitudinal direction and has a connector provided on one side,
wherein the blade housing comprises an upper surface exposing the cutting edge, a lower surface opposite to the upper surface, and a rinsing area extending from the upper surface to the lower surface and across which the blade is disposed in the longitudinal direction,
wherein the razor handle comprises a plunger that provides a pivot restoring force to the razor cartridge, and
wherein, when viewed from the lower surface of the blade housing, the plunger is positioned so as not to overlap the rinsing area in a rest position, one side of the plunger is located on a plane spaced at least ⅛ of a longitudinal width of the rinsing area from the center of the rinsing area toward one side of the rinsing area, and the other side of the plunger is located on a plane spaced at least ⅛ of the longitudinal width of the rinsing area from the center of the rinsing area toward the other side of the rinsing area.

2. The razor assembly of claim 1, wherein the razor cartridge comprises a plurality of blades, and
wherein the pivot axis of the razor cartridge is positioned forward of a foremost blade among the plurality of blades.

3. The razor assembly of claim 1, wherein the razor cartridge comprises a plurality of blades, and
wherein a contact point between the plunger and the blade housing is positioned forward of a foremost blade among the plurality of blades in the rest position.

4. The razor assembly of claim 3, wherein, when the razor cartridge is in the rest position, the cutting edge of the foremost blade is positioned between a first vertical plane perpendicular to the upper surface and contacting a leading end of the plunger and a second vertical plane perpendicular to the upper surface and passing through the contact point.

5. The razor assembly of claim 1, wherein the razor cartridge comprises a plurality of blades, and
wherein a contact point between the plunger and the blade housing is positioned behind a second or third blade from a front among the plurality of blades in a maximum pivot position.

6. The razor assembly of claim 1, wherein the blade housing further comprises a central portion extending across a central part of the rinsing area in a transverse direction on the lower surface, and
wherein a ratio of a longitudinal width of the plunger to a longitudinal width of the central portion is 2 to 8.

7. The razor assembly of claim 1, wherein a leading end of the plunger contacting the blade housing comprises a convex tip surface toward the rinsing area, and
wherein the blade housing comprises a plunger-corresponding surface positioned adjacent to the leading end of the plunger, the plunger-corresponding surface comprises a corresponding curved surface shaped to correspond to the convex tip surface.

8. The razor assembly of claim 1, wherein an upper surface of the plunger comprises a convex curved region configured to allow rinsing fluid to spread toward the rinsing area.

9. The razor assembly of claim 1, wherein an extended plane of an upper surface of the plunger passes through the rinsing area.

10. The razor assembly of claim 1, wherein the razor cartridge comprises a plurality of blades, and
wherein an extended plane of an upper surface of the plunger passes through a rearmost blade among the plurality of blades in the rest position.

11. The razor assembly of claim 9, wherein an effective rinsing guide region defined based on the extended plane of the upper surface of the plunger and a first vertical plane contacting a leading end of the plunger is included within the rinsing area.

12. The razor assembly of claim 1, wherein the razor cartridge comprises a plurality of blades, and
wherein a first vertical plane contacting a leading end of the plunger passes through a foremost blade among the plurality of blades in the rest position.

13. The razor assembly of claim 1, wherein a ratio of a longitudinal width of the plunger to the longitudinal width of the rinsing area is 0.3 to 0.8.

14. A razor assembly comprising a razor cartridge and a razor handle that pivotably supports the razor cartridge,
wherein the razor cartridge comprises:
at least one blade having a cutting edge,
a blade housing that accommodates the blade in a longitudinal direction so that the cutting edge is exposed forwardly and upwardly, and has a connector on one side,
wherein the blade housing comprises an upper surface, a lower surface opposite to the upper surface, a rinsing area extending from the upper surface to the lower surface and across which the blade is arranged longitudinally, and a central portion extending across a central part of the rinsing area on the lower surface in a transverse direction to support the blade,
wherein the razor handle comprises a plunger that provides a pivot restoring force to the razor cartridge,
wherein, when viewed from the lower surface of the blade housing, the plunger is positioned so as not to overlap the rinsing area in a rest position,
wherein an upper surface of the plunger extends longitudinally to guide at least a portion of the rinsing fluid flowing toward the plunger into the rinsing area, and
wherein a ratio of a longitudinal width of the plunger to a longitudinal width of the central portion is 2 to 8.

15. A razor assembly comprising a razor cartridge and a razor handle that pivotably supports the razor cartridge,
wherein the razor cartridge comprises:
at least one blade having a cutting edge,
a blade housing that accommodates the blade in the longitudinal direction so that the cutting edge is exposed forwardly and upwardly, and has a connector on one side,
wherein the blade housing comprises an upper surface, a lower surface opposite to the upper surface, a rinsing area extending from the upper surface to the lower surface and across which the blade is arranged longitudinally, and a central portion extending across a central part of the rinsing area on the lower surface in a transverse direction to support the blade,
wherein the razor handle comprises a plunger that provides a pivot restoring force to the razor cartridge,
wherein, when viewed from the lower surface of the blade housing, the plunger is arranged so as not to overlap the rinsing area in a rest position,
wherein an upper surface of the plunger extends longitudinally to guide at least a portion of the rinsing fluid flowing toward the plunger into the rinsing area, and
wherein a ratio of a longitudinal width of the plunger to a longitudinal width of the rinsing area is 0.3 to 0.8.
